(19) United States
(12) Patent Application Publication
(10) Pub. No.: US 2025/0052852 A1
(43) Pub. Date: Feb. 13, 2025

(54) METHOD AND SYSTEM FOR PROVIDING POSITIONING SERVICE

(71) Applicant: KYONGGI UNIVERSITY INDUSTRY AND ACADEMIA COOPERATION FOUNDATION, Suwon-si, Gyeonggi-do (KR)

(72) Inventor: Sang Won CHOI, Yongin-si, Gyeonggi-do (KR)

(73) Assignee: KYONGGI UNIVERSITY INDUSTRY AND ACADEMIA COOPERATION FOUNDATION, Suwon-si, Gyeonggi-do (KR)

(21) Appl. No.: 18/723,411

(22) PCT Filed: Nov. 9, 2022
(86) PCT No.: PCT/KR2022/017520

§ 371 Date: Jun. 21, 2024

(30) Foreign Application Priority Data
Dec. 23, 2021 (KR) 10-2021-0186242
Dec. 23, 2021 (KR) 10-2021-0186257
Dec. 23, 2021 (KR) 10-2021-0186260

(51) Int. Cl. G01S 5/02

(52) U.S. Cl. CPC G01S 5/0252; G01S 5/0226

(57) ABSTRACT

A method for providing a positioning service according to the present invention provides a positioning service by dividing a service space into a plurality of zones and hierarchically constructing a radio map, wherein a layered radio map is constructed by indexing a communication signal information measured by a measurement terminal at each reference position in each zone divided by layer with respect to one service space, and a similarity between the communication signal information received from a user terminal and the indexing information is calculated so as to search for a zone where the user terminal is located.

### TECHNICAL FIELD

The present invention relates to a positioning technology, and more particularly, to a technology for searching a location of a user terminal using a hierarchical structured radio map that can set independent zone resolutions for each provided positioning service.

### BACKGROUND ART

Although a positioning system using GPS is widely used, it has a problem that only rough positioning is feasible due to non-negligible positioning errors, and positioning is infeasible in places where GPS signals cannot reach, such as indoor or tunnel environment.

To solve such a problem, indoor positioning technologies by leveraging wireless communication technologies such as wireless LAN (WLAN), ultra-wideband (UWB), Bluetooth Low Energy (BLE), and Zigbee are emerging. These indoor positioning technologies provide relatively more accurate indoor location information based on positioning methods such as triangulation and fingerprint.

The indoor positioning technology estimates the location using communication signal information such as received signal strength indication (RSSI) of signals received from one or more anchors such as access points or beacons installed at predetermined reference point(s).

The fingerprint method divides an indoor space into small multiple zones, configures a radio map that databased communication signal information of signals received from each anchor. Here, databased communication signal information is measured for each predetermined reference position representing each zone in advance. Subsequently, the location of a user terminal is estimated by comparing the communication signal information of signals received from each anchor measured at the user terminal whose location is to be positioned with those at the multiple candidate reference positions to search the most similar reference position.

The size of the divided zone in the fingerprint method is determined according to the quality of the communication signal information used, and generally, one type of communication signal information such as RSSI is used. Since the size of the zone is determined according to the quality of the communication signal information used in the fingerprint method, the zone resolution cannot be independently set for each provided positioning service.

### DETAILED DESCRIPTION OF THE INVENTION

An object of the present invention is to provide a method of configuring a hierarchical radio map that divides zones by independently setting the size of the zone according to various positioning accuracies given space of interest.

Another object of the present invention is to provide a method of configuring a radio map using various communication signal information according to the communication signal quality to divide zones, and configuring a radio map using combined communication signal information to improve positioning accuracy.

Additionally, another object of the present invention is to provide a method capable of independently setting the resolution of divided zone for each provided positioning service.

Additionally, another object of the present invention is to provide a method that can efficiently search the location of a user terminal by reducing the search range using a hierarchically configured radio map.

In a method for providing a positioning service by dividing a service space into a plurality of layers and a plurality of zones for each layer based on communication signal information of signals transmitted by D (natural number) transmitters by a positioning service system according to the present invention, the method includes a service mapping step, a communication signal information receiving step, an indexing step, a hierarchy relationship setting step, a radio map configuring step, a positioning request receiving step, and a searching step.

The service mapping step is a step of mapping a provided positioning service and a layer set in a service space.

The communication signal information receiving step is a step of receiving D communication signal information measured at each reference position of zones divided in each layer for one service space based on layer-specific zone configuration information from a measurement terminal.

The indexing step is a step of mapping and indexing the D communication signal information measured and received at each reference position to a corresponding zone ID, and performing indexing sequentially from the lowermost layer to the uppermost layer.

The hierarchy relationship setting step is a step of setting a hierarchical relationship for each zone based on the layer-specific zone configuration information.

The radio map configuring step is a step of configuring and storing a radio map including zone indices and hierarchical relationships between zones.

The positioning request receiving step is a step of receiving a service identifier and D communication signal information measured at a corresponding location from a user terminal located in a service space.

The searching step is a step of searching a zone among multiple candidate zones where the user terminal is located by obtaining a similarity between the communication signal information received from the user terminal and that of reference position from candidate indexed zone, where all the candidate indexed zones are mapped to the service.

At this time, the similarity metric used in the searching step is either a Euclidean distance or a correlation calculated between the communication signal information received from the user terminal and that of reference position from candidate indexed zone, where all the candidate indexed zones are mapped to the service. In the case of the Euclidean distance, the smaller the value, the higher the similarity, and in the case of the correlation, the larger the value, the higher the similarity.

At this time, the communication signal information used is one of positioning information including Received Signal Strength Indicator (RSSI), Reference Signal Received Power (RSRP), Reference Signal Received Quality (RSRQ), Angle of Arrival (AoA), and Time of Flight (ToF). Here, the communication signal information used in each layer may be set independently.

In addition, at least one layer among the plurality of layers may use a combination of multiple communication signal information for characterizing zone.

According to another aspect of the present invention, the positioning service providing method may further include an upper layer searching step, and the upper layer searching step is a step of searching a zone where the user terminal is located for one or more upper layers of the layer mapped to the service, and searching a zone of the upper layer where the user terminal is located by obtaining a similarity between the communication signal information of the upper layer and that of reference position from candidate indexed zone of the upper layer.

According to the present invention, it is possible to configure a hierarchical radio map that divides zones by independently setting the size of the zone according to various positioning accuracies given space of interest.

In addition, according to the present invention, it is possible to configure a radio map that divides zones using various communication signal information according to the communication signal quality, and configure a radio map using combined communication signal information to improve positioning accuracy.

In addition, according to the present invention, it is possible to independently set the zone resolution for each provided positioning service.

In addition, according to the present invention, it is possible to efficiently search the location of a user terminal by reducing the search range using a hierarchically configured radio map.

### BRIEF DESCRIPTION OF THE DRAWINGS

FIG. 1 is an example of a radio map configured based on communication signal information of RSSI.

FIG. 2 is an example of a radio map hierarchically configured by setting two layers for a service given space of interest.

FIG. 3 is an example of a radio map in which zones belonging to the same layer have different lower layers.

FIG. 4 illustrates a procedure for configuring a hierarchical radio map according to an embodiment of the present invention.

FIG. 5 illustrates a procedure of a method for providing a positioning service according to an embodiment of the present invention.

FIG. 6 illustrates a procedure of a method for providing a positioning service according to another embodiment of the present invention.

FIG. 7 is a block diagram of a positioning service system according to an aspect of the present invention.

The aforementioned and additional aspects are embodied through the embodiments described with reference to the accompanying drawings. The components of each embodiment can be variously combined within the embodiment unless otherwise mentioned or contradictory to each other. The blocks in the block diagram may represent a physical part in some cases, but in other cases, it may be a logical representation of a function of a physical part or functions across multiple physical parts. Sometimes, the entity of a block or a part thereof may be a set of program instructions. These blocks may be implemented in whole or in part by hardware, software, or a combination thereof.

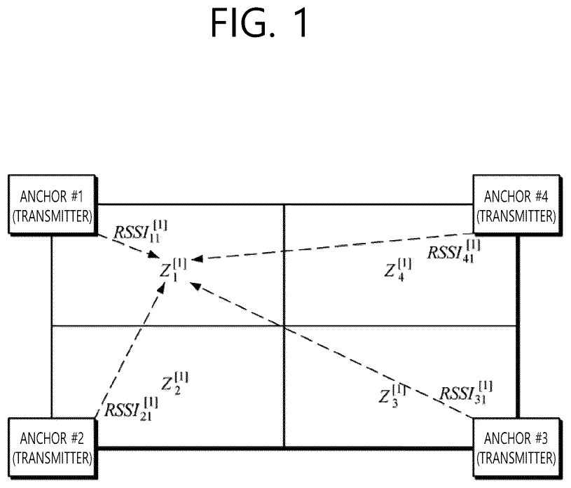

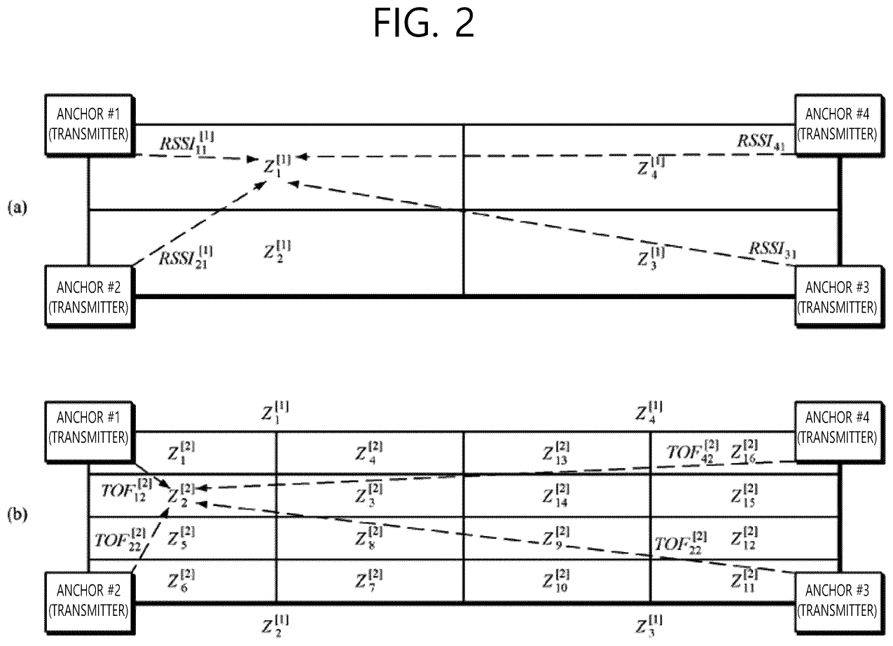

FIG. 1 is an example of a radio map configured based on communication signal information of RSSI, and FIG. 2 is an example of a radio map hierarchically configured by setting two layers for one service space.

The radio map in FIG. 1 divides the service space into four zones based on received signal strength information (RSSI), which is one of the communication signal information of signals received from four anchors whose absolute or relative positions are known, and zone indexing is done based on four received signal strength information. That is, the zone with zone ID Z₁^{[1]} can be indexed as (RSSI₁₁^{[1]}, RSSI₂₁^{[1]}, RSSI₃₁^{[1]}, RSSI₄₁^{[1]}) by combining RSSI₁₁^{[1]} of the signal received from anchor #1, RSSI₂₁^{[1]} of the signal received from anchor #2, RSSI₃^{[1]} of the signal received from anchor #3, and RSSI₄₁^{[1]} of the signal received from anchor #4 measured by the measurement terminal (100) at the reference position of the zone with zone ID Z₁^{[1]}. Here, the superscript [1] means layer #1, and the subscript 1 represents zone number in the corresponding layer. The example in FIG. 1 is an example of a radio map with only one layer set.

The two radio maps shown in FIG. 2 represent the composition of each layer, where (a) is a radio map for layer #1 and (b) is a radio map for layer #2. The radio map shown in FIG. 2(a) is the same as that shown in FIG. 1, and the radio map shown in FIG. 2(b) is a radio map for layer #2, which is a lower layer of layer #1 shown in FIG. 2(a), where each divided zone in layer #1 is further divided into four small zones, totaling 16 divided zones. For example, the zone Z₁^{[1]} of layer #1 is divided into zones Z₁^{[2]}, Z₂^{[2]}, Z₃^{[2]}, and Z₄^{[2]} in layer #2. In the example of FIG. 2, layer #2 divides zones using timing information, i.e., TOF (Time of Flight) communication signal information. Z₂^{[2]} can be indexed as (TOF₁₂^{[2]}, TOF₂₂^{[2]}, TOF₃₂^{[2]}, TOF₄₂^{[2]}) using ToF of signals received from four anchors to the reference position of zone with zone ID Z₂^{[2]}. As the number of layers increases, i.e., the lower layers, the size of the divided zone decreases, so the quality of the communication signal information for dividing these zones should be higher. In the example of FIG. 2, layer #1 divides the space of interest into four zones using RSSI, and layer #2 divides the space of interest into 16 zones using TOF, which has a higher communication signal information quality than RSSI. The example in FIG. 2 is just one example, assuming that TOF has a higher communication signal information quality than RSSI, but the quality may vary depending on the performance of the anchor, environment, etc., so it should be appropriately selected according to the divided zone resolution required for each layer.

The method for providing a positioning service by the positioning service system (10) according to the present invention includes a service mapping step, a communication signal information receiving step, an indexing step, a hierarchy relationship setting step, a radio map configuring step, a positioning request receiving step, and a searching step.

The positioning service system (10) according to the present invention may include a measurement terminal (100), a service server (200), a user terminal (300), and a billing server (400). The configuration of the positioning service system (10) will be described later.

The service mapping step, the communication signal information receiving step, the indexing step, the hierarchy relationship setting step, the radio map configuring step, the positioning request receiving step, and the searching step can be implemented with at least part of their functions as a set of computer program instructions executed on a computer.

The positioning service system (10) according to the present invention provides a positioning service by dividing a service space into a plurality of layers and a plurality of zones for each layer based on communication signal information of signals transmitted by D (natural number) transmitters.

The communication signal information receiving step, the indexing step, the hierarchy relationship setting step, and the radio map configuring step constitute a method for the positioning service system (10) according to the present invention to hierarchically configure a radio map.

A radio map is a database of communication signal information of signals received from each anchor, which is measured at each reference position of each zone in advance. The positioning service system (10) according to the present invention can set one or more layers for one service space and set zones by dividing each layer, and this setting is stored in layer-specific zone configuration information. Each layer has a hierarchical relationship, and the higher the layer number, the lower the layer. In the example shown in FIG. 2, two layers are set for one space, where layer #1 divides the space of interest into four zones and layer #2 divides the space of interest into 16 zones. In addition, in the example shown in FIG. 2, layer #2 is set as a lower layer of layer #1, so each zone of layer #1 is subdivided into four lower zones of layer #2. Therefore, the radio map configured by the positioning service system (10) is configured so that the radio map of each layer has a hierarchical structure. At this time, the positioning service system (10) divides the service space into a plurality of zones based on the communication signal information of signals transmitted by D (natural number) transmitters. In the example shown in FIGS. 1 and 2, the transmitter is an anchor, and four (D=4) transmitters are used to divide the service space of interest into zones. The anchor, i.e., transmitter, may be a base station of a mobile communication system, a WiFi AP, a UWB AP, a BLE beacon, etc., but is not limited thereto.

The service mapping step is a step in which the positioning service system (10), specifically the service server (200), maps a layer for each provided positioning service. The various positioning services provided by the positioning service system (10) may have independent divided zone resolutions. Therefore, the service server (200) sets a plurality of layers with independent divided zone resolutions, and then maps a layer with a divided zone resolution suitable for the positioning service to the corresponding service.

The communication signal information receiving step is a step in which the positioning service system (10), specifically the service server (200), receives D communication signal information measured at each reference position of zones divided in each layer for one service space based on layer-specific zone configuration information from the measurement terminal (100). To configure a radio map, the positioning service system (10) needs to measure communication signal information from D transmitters at the reference position of each divided zone using the measurement terminal (100). The reference position may be a representative location of the corresponding zone, such as the center point or centroid of the zone. The measurement terminal (100) sequentially measures the communication signal information at the reference position of all zones of each layer for all set of layers and delivers the measured information to the service server (200). In the example shown in FIG. 2, the measurement terminal (100) measures and reports the communication signal information at the reference position of each zone from zone Z₁^{[1]} to zone Z₁^{[4]} for layer #1, and then measures and reports the communication signal information at the reference position of each zone from zone Z₁^{[2]} to zone Z₁₆^{[2]} for layer #2. The order of layers measured by the measurement terminal (100) may be from the upper layer to the lower layer or from the lower layer to the upper layer, but is not limited thereto, and measurements may be performed in a predetermined order of zones.

The communication signal information measured at the reference position and transmitted to the positioning service system (10), specifically the service server (200), by the measurement terminal (100) consists of communication signal information from D transmitters. For example, in the example of FIG. 2, the communication signal information measured and transmitted at the reference position of the zone consists of RSSI₁₁^{[1]}, RSSI₂₁^{[1]}, RSSI₃₁^{[1]}, and RSSI₄₁^{[1]}.

The positioning service system (10), specifically the service server (200), stores the communication signal information received from the measurement terminal (100) together with information that can identify the reference position.

The indexing step is a step in which the positioning service system (10), specifically the service server (200), maps and indexes the D communication signal information measured and received at each reference position to the zone to which the reference position belongs, and performs indexing sequentially from the lowermost layer to the uppermost layer. Indexing means mapping the corresponding zone as a combination of D communication signal information. The service server (200) maps and indexes the communication signal information received and stored from the measurement terminal (100) to each zone. That is, the service server (200) makes the combination of D communication signal information identifiable for each zone of each layer.

In the future, when the user terminal (300) transmits the communication signal information of signals received from D transmitters at its current location to the service server (200), the service server (200) compares it with the communication signal information received at each reference position to find the most similar reference position. This is done so that the corresponding zone can be identified as the zone where the user terminal (300) is currently located on the radio map. Indexing is performed for this purpose.

The positioning service system (10), specifically the service server (200), repeatedly performs indexing from the lowermost layer with the highest divided zone resolution to the uppermost layer with the lowest divided zone resolution. In the example of FIG. 2, indexing is performed as (Z₁^{[2]}, Z₂^{[2]}, . . . , Z₁₆^{[2]}) for all zones belonging to layer #2, and then indexing is performed as (Z₁^{[1]}, Z₂^{[1]}, Z₃^{[1]}, Z₄^{[1]}) for all zones belonging to layer #1.

The hierarchy relationship setting step is a step in which the positioning service system (10), specifically the service server (200), sets a hierarchical relationship for each zone based on the layer-specific zone configuration information. For example, in FIG. 2, zones Z₁^{[2]}, Z₂^{[2]}, Z₃^{[2]}, and Z₄^{[2]} are set as lower-level zones for zone Z₁^{[1]}. The search range of the lower layer can be reduced by using the hierarchical relationship between zones. That is, in a service that requires the divided zone resolution of layer #2, the location of the user terminal (300) is first searched in layer #1, and then the search range can be reduced by searching only for the lower-level zones of the corresponding zone in layer #2.

The radio map configuring step is a step in which the positioning service system (10), specifically the service server (200), configures and stores a radio map including indexing for zones and hierarchical relationships between zones for each layer.

The positioning request receiving step is a step in which the positioning service system (10), specifically the service server (200), receives a service identifier and D communication signal information measured at the corresponding location transmitted by the user terminal (300) located in the service space to identify the zone where it is currently located. The service identifier is an identifier for distinguishing the positioning service, and the service server (200) finds the layer mapped to the service identifier and finds the zones allocated to the corresponding layer.

The searching step is a step in which the positioning service system (10), specifically the service server (200), searches for the zone where the user terminal (300) is located by obtaining a similarity between the communication signal information received from the user terminal (300) and the indexes of all zones mapped to the service. The service server (200) calculates the similarity between the communication signal information measured and transmitted by the user terminal (300) at its current location and the communication signal information measured at the reference position for all zones belonging to the layer mapped to the corresponding service, and determines that the zone with the highest similarity index is where the terminal is currently located.

At this time, the similarity used in the searching step is either a Euclidean distance or a correlation calculated between the communication signal information received from the user terminal (300) and the indices of all zones mapped to the service. In the case of the Euclidean distance, the smaller the value, the higher the similarity, and in the case of the correlation, the larger the value, the higher the similarity. The calculation of the Euclidean distance is a well-known calculation method, so a detailed description will be omitted, and the calculation of the correlation is used in the correlation analysis method used in statistics, and there is no restriction on the correlation coefficient.

The communication signal information measured by the measurement terminal (100) at the reference position may be one of the positioning information including RSSI, RSRP, RSRQ, AOA, and TOF.

Each positioning information is well-known information, so a detailed description will be omitted.

The positioning service providing method according to the present invention sets a plurality of layers for the service space of interest and configures a radio map for each layer. At this time, the communication signal information used for each layer may be set independently. Therefore, all layers may use the same communication signal information, for example, RSSI, or each layer may use all different communication signal information. In addition, only some layers may use the same communication signal information.

At this time, at least one layer among the plurality of layers set for the service space of interest may use a combination of a plurality of communication signal information for distinguishing zone. For example, two positioning information, RSSI and TOF, can be used as communication signal information for distinguishing zones.

Additionally, the method for providing a positioning service by the positioning service system (10) according to the present invention may further include a billing data generation step.

The billing data generation step is a step in which the positioning service system (10), specifically the billing server (400), generates billing data according to positioning service usage information for each user terminal. The billing server (400) may generate billing data according to the usage information of the positioning service used by the user terminal (300) according to the set billing policy, and then impose billing on the user terminal (300) or the service provider providing the corresponding positioning service.

The billing server (400) may include a physical storage device such as a memory to store positioning service usage information for each user terminal. At this time, the billing server (400) may generate billing data based on the stored positioning service usage information for each terminal.

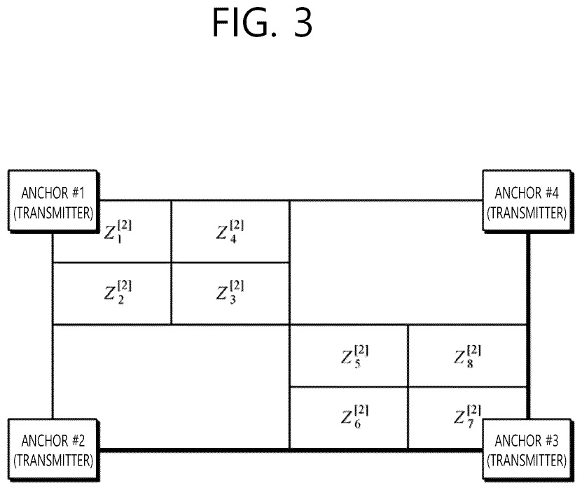

FIG. 3 is an example of a radio map in which zones belonging to the same layer have different lower layers. The radio map configuration described above is the case where all zones belonging to the same layer are set to have the same number of lower layers. On the other hand, the positioning service system (10) according to the present invention can set the zones belonging to the same layer to have irregular lower layers when configuring a radio map. FIG. 3 shows an irregularly hierarchized radio map where lower layers are set for zones Z₁^{[1]} and Z₃^{[1]} of layer #1, but lower layers are not set for zones Z₂^{[1]} and Z₄^{[1]}. This is because, depending on the type of service, zone division may need to be subdivided for some zones but not for others.

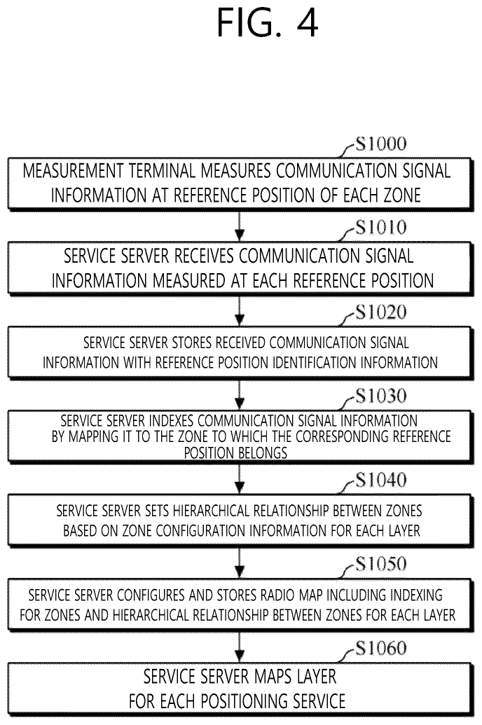

FIG. 4 illustrates a procedure for configuring a hierarchical radio map according to an embodiment of the present invention. The measurement terminal (100) measures the communication signal information from the transmitters at the reference position of each zone required to configure a radio map (S1000). The service server (200) receives the communication signal information measured at each reference position of zones divided for each layer from the measurement terminal (100) (S1010). The service server (200) stores the communication signal information received from the measurement terminal (100) together with information that can identify the reference position (S1020). The service server (200) maps and indexes the D communication signal information measured and received at each reference position to the zone to which the reference position belongs, sequentially from the lowermost layer to the uppermost layer (S1030). The service server (200) sets a hierarchical relationship for each zone based on the layer-specific zone configuration information (S1040). The service server (200) configures and stores a radio map including indexing for zones and hierarchical relationships between zones for each layer (S1050). The service server (200) maps a layer for each provided positioning service (S1060).

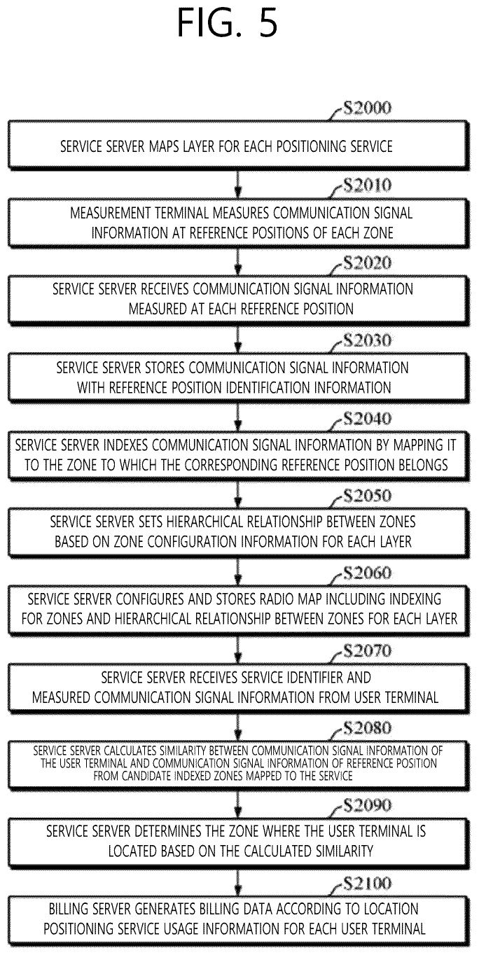

FIG. 5 illustrates a procedure of a method for providing a positioning service according to an embodiment of the present invention. The service server (200) maps a layer for each provided positioning service (S2000). The measurement terminal (100) measures the communication signal information from the transmitters at the reference position of each zone required to configure a radio map (S2010). The service server (200) receives the communication signal information measured at each reference position of zones divided for each layer from the measurement terminal (100) (S2020). The service server (200) stores the communication signal information received from the measurement terminal (100) together with information that can identify the reference position (S2030). The service server (200) maps and indexes the D communication signal information measured and received at each reference position to the zone to which the reference position belongs, sequentially from the lowermost layer to the uppermost layer (S2040). The service server (200) sets a hierarchical relationship for each zone based on the layer-specific zone configuration information (S2050). The service server (200) configures and stores a radio map including indexing for zones and hierarchical relationships between zones for each layer (S2060). The service server (200) receives a service identifier and D communication signal information measured at the corresponding location from the user terminal (300) located in the service space (S2070). The service server (200) searches for the zone where the user terminal (300) is located by obtaining a similarity between the communication signal information received from the user terminal (300) and that of reference position from candidate indexed zone, where all the candidate indexed zones are mapped to the service (S2080). At this time, the zone of the index with the highest similarity is determined as the zone where the user terminal (300) is located (S2090). The billing server (400) generates billing data according to the positioning service usage information for each user terminal (S2100).

According to another aspect of the present invention, the method for providing a positioning service may include a service mapping step, a communication signal information receiving step, an indexing step, a hierarchy relationship setting step, a radio map configuring step, a positioning request receiving step, an upper layer searching step, and a searching step.

The service mapping step, the communication signal information receiving step, the indexing step, the hierarchy relationship setting step, the radio map configuring step, the positioning request receiving step, and the searching step are the same as described above.

The upper layer searching step can be implemented with at least part of its functions as a set of computer program instructions executed on a computer.

The upper layer searching step is a step in which the positioning service system (10), specifically the service server (200), searches for the zone where the user terminal (300) is located for one or more upper layers of the layer mapped to the service. Similar to the searching step described above, the service server (200) searches for the zone of the upper layer where the user terminal (300) is located by obtaining a similarity between the communication signal information of the upper layer received from the user terminal (300) and that of reference position from candidate indexed zone, where all the candidate indexed zones are of the corresponding upper layer.

At this time, if the communication signal information used in the upper layer is the same as the communication signal information used in the layer mapped to the service used by the user terminal (300), the search can be performed immediately. However, if the communication signal information used in the layer mapped to the service and the communication signal information of the upper layer are different, the step of searching for the zone where the user terminal (300) is located in the upper layer includes a step of the service server (200) requesting and obtaining the communication signal information used in the corresponding layer from the user terminal (300).

The positioning service system (10), specifically the service server (200), can reduce the range of calculating similarity of the user terminal (300) by using the hierarchized radio map. Therefore, if there is an upper layer of the layer of the positioning service currently used by the user terminal (300), the service server (200) needs to first search for the zone where the user terminal (300) is located in at least one or more upper layers. This is because the upper layer has fewer zones than the lower layer, so the number of indexes for which similarity should be calculated is smaller. However, since the communication signal information of the upper layer may be different from the communication signal information sent by the user terminal (300) when requesting positioning, in this case, the service server (200) should request and obtain the corresponding communication signal information from the user terminal (300). Therefore, since it is only necessary to search for the zones belonging to the lower layers of the zone found in the upper layer, the number of target zones for searching is reduced, so the zone where the user terminal (300) is located can be calculated more efficiently.

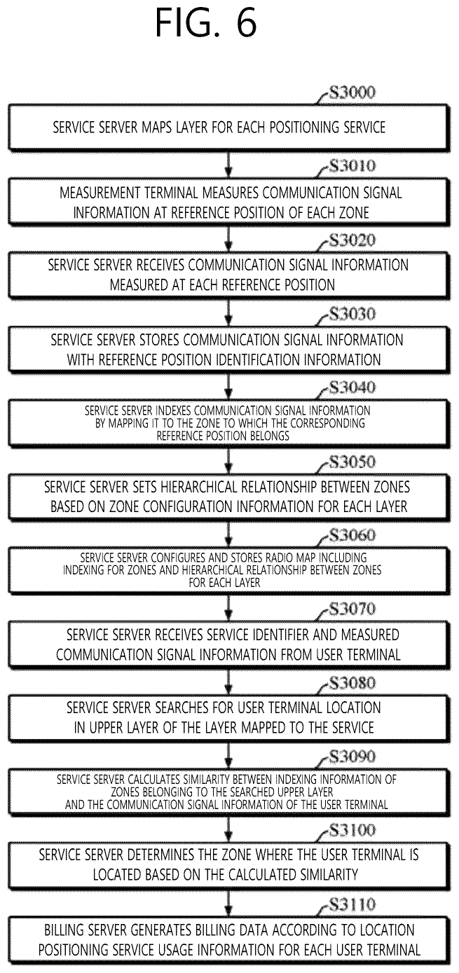

FIG. 6 illustrates a procedure of a method for providing a positioning service according to another embodiment of the present invention. The procedure shown in FIG. 6 involves searching first in the upper layer, which allows for a quicker search for the location of the user terminal (300) compared to the procedure shown in FIG. 5. The service server (200) maps a layer for each provided positioning service (S3000). The measurement terminal (100) measures the communication signal information from the transmitters at the reference position of each zone required to configure a radio map (S3010). The service server (200) receives the communication signal information measured at each reference position of zones divided for each layer from the measurement terminal (100) (S3020). The service server (200) stores the communication signal information received from the measurement terminal (100) together with information that can identify the reference position (S3030). The service server (200) maps and indexes the D communication signal information measured and received at each reference position to the zone to which the reference position belongs, sequentially from the lowermost layer to the uppermost layer (S3040). The service server (200) sets a hierarchical relationship for each zone based on the layer-specific zone configuration information (S3050). The service server (200) configures and stores a radio map including indexing for zones and hierarchical relationships between zones for each layer (S3060). The service server (200) receives a service identifier and D communication signal information measured at the corresponding location from the user terminal (300) located in the service space (S3070). The service server (200) checks whether there is an upper layer of the layer mapped to the service identified by the service identifier. If there is an upper layer, it first searches for the location of the user terminal (300) in the corresponding layer for one or more upper layers (S3080). Thereafter, the zone where the user terminal (300) is located is found by calculating similarity for the zones belonging to lower layers of the searched layer (S3090). At this time, the zone of the index with the highest similarity is determined as the zone where the user terminal (300) is located (S3100). The billing server (400) generates billing data according to the positioning service usage information for each user terminal (S3110).

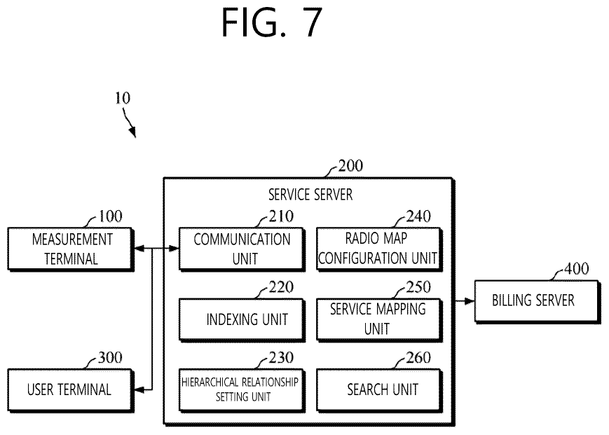

FIG. 7 is a block diagram of a positioning service system according to an aspect of the present invention. The positioning service system (10) according to the present invention includes a measurement terminal (100) and a service server (200).

The measurement terminal (100) is a terminal that measures requested communication signal information at each reference position of zones divided for each layer set for one service space based on layer-specific zone configuration information.

The service server (200) includes a communication unit (210), an indexing unit (220), a hierarchy relationship setting unit (230), a radio map configuration unit (240), a service mapping unit (250), and a searching unit (260).

The service server (200) is a computing device that includes not only hardware but also software concepts. That is, the service server (200) may refer to physical hardware, but may also refer to a program executed on the corresponding hardware. The service server (200) is a device that includes a processor and a memory connected to the processor and including program instructions executable by the processor. The device may further include a storage device, a display, an input device, etc. in addition to the processor and the memory. The processor is a processor that executes program instructions that implement the program, and the memory is connected to the processor and stores program instructions executable by the processor, data used by the processor for computation, data processed by the processor, etc.

The communication unit (210), the indexing unit (220), the hierarchy relationship setting unit (230), the radio map configuration unit (240), the service mapping unit (250), and the searching unit (260) are composed of a set of computer program instructions with at least part of their functions executed on the processor of the service server (200).

A radio map is a database of communication signal information of signals received from each anchor measured for each reference position of each zone in advance. The service server (200) according to the present invention can set one or more layers for one service space and set zones by dividing each layer, and this setting is stored in layer-specific zone configuration information. Each layer has a hierarchical relationship, and the higher the layer number, the lower the layer. In the example shown in FIG. 2, two layers are set for one space, where layer #1 divides the space into four zones and layer #2 divides the space into 16 zones. In addition, in the example shown in FIG. 2, layer #2 is set as a lower layer of layer #1, so each zone of layer #1 is subdivided into four lower zones of layer #2. Therefore, the radio map configured by the service server (200) is configured so that the radio map of each layer has a hierarchical structure. At this time, the service server (200) divides the service space into a plurality of zones based on the communication signal information of signals transmitted by D (natural number) transmitters.

The service mapping unit (250) maps a layer for each provided positioning service.

The various positioning services provided by the positioning service system (10) may have independent divided zone resolutions. Therefore, the service mapping unit (250) maps a service requiring an appropriately divided zone resolution to each of the plurality of layers set with independent divided zone resolutions.

The communication unit (210) receives D communication signal information measured at each reference position of divided zones for each layer set for one service space based on layer-specific zone configuration information from the measurement terminal (100). The communication unit (210) also receives a service identifier and communication signal information measured at the corresponding location from the user terminal (300). To configure a radio map, communication signal information from D transmitters needs to be measured at the reference position of each divided zone using the measurement terminal (100). The reference position may be a representative location of the corresponding zone, such as the center point or centroid of the zone. The measurement terminal (100) sequentially measures the communication signal information at the reference position of all zones of each layer for all set layers and delivers the measured information to the service server (200). In the example shown in FIG. 2, the measurement terminal (100) measures and reports the communication signal information at the reference position of each zone from zone Z₁^{[1]} to zone Z₄^{[1]} for layer #1, and then measures and reports the communication signal information at the reference position of each zone from zone Z₁^{[2]} to zone Z₁^{[16]} for layer #2. The order of layers measured by the measurement terminal (100) may be from the upper layer to the lower layer or from the lower layer to the upper layer, but is not limited thereto, and measurements may be performed in a predetermined order of zones.

The communication signal information received by the communication unit (210) consists of communication signal information from D transmitters. For example, in the example of FIG. 2, the communication signal information measured and transmitted at the reference position of zone Z₁^{[1]} consists of RSSI₁₁^{[1]}, RSSI₂₁^{[1]}, RSSI₃₁^{[1]}, and RSSI₄₁^{[1]}.

The service server (200) stores the communication signal information received by the communication unit (210) together with information that can identify the reference position.

The indexing unit (220) maps and indexes the D communication signal information measured and received at each reference position to the zone to which the reference position belongs, and performs indexing sequentially from the lowermost layer to the uppermost layer. Indexing means mapping the corresponding zone as a combination of D communication signal information. The indexing unit (220) maps and indexes the communication signal information received and stored from the measurement terminal (100) to each zone. That is, the indexing unit (220) makes the combination of D communication signal information identifiable for each zone of each layer.

In the future, when the user terminal (300) transmits the communication signal information of signals received from D transmitters at its current location to the service server (200), the service server (200) compares it with the communication signal information received at each reference position to find the most similar reference position, so that the corresponding zone is the zone where the user terminal (300) is currently located and can be identified as which zone on the radio map. Indexing is performed for this purpose.

The indexing unit (220) repeatedly performs indexing from the lowermost layer with the highest divided zone resolution to the uppermost layer with the lowest divided zone resolution. In the example of FIG. 2, indexing is performed for all zones (Z₁^{[2]}, Z₂^{[2]}, . . . , Z₁₆^{[2]}) belonging to layer #2, and then indexing is performed for all zones (Z₁^{[1]}, Z₂^{[1]}, Z₃^{[1]}, Z₄^{[1]}) belonging to layer #1.

The hierarchy relationship setting unit (230) sets a hierarchical relationship for each zone based on the layer-specific zone configuration information. For example, in FIG. 2, zones Z₁^{[2]}, Z₂^{[2]}, Z₃^{[2]}, and Z₄^{[2]} are set as lower-level zones for zone Z₁^{[1]}. The search range of the lower layer can be reduced by using the hierarchical relationship between zones. That is, in a service that requires the divided zone resolution of layer #2, the location of the user terminal (300) is first searched in layer #1, and then the search range can be reduced by searching only for the lower-level zones of the corresponding zone in layer #2.

The radio map configuration unit (240) configures and stores a radio map including indexing for zones and hierarchical relationships between zones for each layer.

The searching unit (260) searches for the zone where the user terminal (300) is located by obtaining a similarity between the communication signal information received from the user terminal (300) and that of reference position from candidate indexed zone, where all the candidate indexed zones are mapped to the service.

The searching unit (260) calculates the similarity between the communication signal information measured and transmitted by the user terminal (300) at its current location and the communication signal information measured at the reference position for all zones belonging to the layer mapped to the corresponding service, and determines that the zone with the highest similarity index is where the terminal is currently located.

At this time, the similarity used by the searching unit (260) is either a Euclidean distance or a correlation calculated between the communication signal information received from the user terminal (300) and the indexes of all zones mapped to the service. In the case of the Euclidean distance, the smaller the value, the higher the similarity, and in the case of the correlation, the larger the value, the higher the similarity. The calculation of the Euclidean distance is a well-known calculation method, so a detailed description will be omitted, and the calculation of the correlation is used in the correlation analysis method used in statistics, and there is no restriction on the correlation coefficient.

The communication signal information measured by the measurement terminal (100) at the reference position may be one of the positioning information including, RSRP, AOA, and TOF.

Each positioning information is well-known information, so a detailed description will be omitted.

The positioning service system (10) according to the present invention sets a plurality of layers for the service space and configures a radio map for each layer. At this time, the communication signal information used for each layer may be set independently. Therefore, all layers may use the same communication signal information, for example, RSSI, or each layer may use all different communication signal information. In addition, only some layers may use the same communication signal information.

At this time, at least one layer among the plurality of layers set for the service space may use a combination of a plurality of communication signal information for zone division. For example, two positioning information, RSSI and TOF, can be used as communication signal information for dividing zones.

The service server (200) according to the present invention can set the radio map so that all zones belonging to the same layer have the same number of lower layers, but can also set the radio map so that the zones belonging to the same layer have irregular lower layers. FIG. 3 shows an irregularly hierarchized radio map where lower layers are set for zones Z₁^{[1]} and Z₃^{[1]} of layer #1, but lower layers are not set for zones Z₂^{[1]} and Z₄^{[1]}. This is because, depending on the type of service, zone division may need to be subdivided for some zones but not for others.

According to an aspect of the invention, the searching unit (260) may search for the zone where the user terminal (300) is located for one or more upper layers of the layer mapped to the service, and search for the zone where the user terminal (300) is located by obtaining a similarity between the indexes of the zones belonging to the service-mapped zones searched in the upper layer and the communication signal information received from the user terminal (300).

The searching unit (260) can reduce the range for calculating similarity for the user terminal (300) by using the hierarchized radio map. If there is an upper layer of the layer of the positioning service currently used by the user terminal (300), the searching unit (260) first searches for the zone where the user terminal (300) is located in at least one or more upper layers. This is because the upper layer has fewer zones than the lower layer, so the number of indexes for which similarity should be calculated is smaller. However, since the communication signal information of the upper layer may be different from the communication signal information sent by the user terminal (300) when requesting positioning, in this case, the service server (200) should request and obtain the corresponding communication signal information from the user terminal (300). Since it is only necessary to search for the zones belonging to the lower layers of the zone found in the upper layer, the number of target zones for searching is reduced, so the zone where the user terminal (300) is located can be calculated more efficiently.

According to an additional aspect of the present invention, the positioning service system (10) may further include a billing server (400).

The billing server (400) is a computing device that includes not only hardware but also software concepts. That is, the billing server (400) may refer to physical hardware, but may also refer to a program executed on the corresponding hardware. The billing server (400) is a device that includes a processor and a memory connected to the processor and including program instructions executable by the processor. The device may further include a storage device, a display, an input device, etc. in addition to the processor and the memory. The processor is a processor that executes program instructions that implement the program, and the memory is connected to the processor and stores program instructions executable by the processor, data used by the processor for computation, data processed by the processor, etc.

The billing server (400) generates billing data according to the positioning service usage information for each user terminal. The billing server (400) may generate billing data according to the usage information of the positioning service used by the user terminal (300) according to the set billing policy, and then impose billing on the user terminal (300) or the service provider providing the corresponding positioning service.

According to an additional aspect of the present invention, the billing server (400) may include a zone usage information storage unit. The zone usage information storage unit may include a physical storage device such as a memory to receive and store positioning service usage information for each user terminal from the service server (200). At this time, the billing server (400) may generate billing data based on the stored positioning service usage information for each terminal.

According to another aspect of the present invention, the service server (200) may aperiodically request communication signal information from the user terminal (300) in the service space. The service server (200) may request communication signal information from the user terminal (300) by a positioning request message in order to identify the current location of the user terminal (300) when an event occurs between the user terminal (300) and the transmitter (anchor), or when the user terminal (300) requests some service from the service server (200). Alternatively, if the user terminal (300) does not periodically transmit the communication signal information depending on the positioning service, the service server (200) may aperiodically request the communication signal information.

The user terminal (300) located in the service space that receives a request for communication signal information transmits a service identifier and D communication signal information measured at the corresponding location.

According to an additional aspect of the present invention, the user terminal (300) may aperiodically measure and transmit communication signal information to the service server (200) even without a positioning request message from the service server (200). When the user terminal (300) needs to identify its current location by user request or when an unexpected event occurs in the user terminal (300), it can aperiodically measure and transmit communication signal information without the request of the service server (200).

According to an aspect of the invention, the billing server (400) may apply different billing policies according to the service used by the user terminal (300). Since the required zone resolution differs depending on the positioning service, the billing server (400) may apply different billing policies according to the positioning service. At this time, the billing server (400) may generate higher billing data as the zone resolution of the positioning service is higher.

Even for the user terminal (300) using the same positioning service, the resources provided for the corresponding service differ depending on the frequency or time of use, so the billing server (400) may apply different billing policies according to the service usage. At this time, the billing server (400) may generate higher billing data as the usage time or usage frequency of the positioning service used by the user terminal (300) is higher.

Although the present invention has been described through embodiments with reference to the accompanying drawings, it is not limited thereto, and it should be interpreted as including various modifications that can be derived from them by those skilled in the art. The claims are intended to encompass such modifications.

What is claimed is:

1. A method for providing a positioning service by dividing a service space into a plurality of layers and a plurality of zones for each layer based on communication signal information of signals transmitted by D (natural number) transmitters by a positioning service system, the method comprising:
mapping a provided positioning service and layers set in a service space;
receiving, from a measurement terminal, D communication signal information measured at each reference position of zones divided in each layer for one service space based on layer-specific zone configuration information;
mapping and indexing D communication signal information measured and received at each reference position to a corresponding zone ID, and performing indexing sequentially from a lowermost layer to an uppermost layer;
setting a hierarchical relationship for each zone based on layer-specific zone configuration information;
configuring and storing a radio map including indexing for zones and hierarchical relationships between zones;
receiving a service identifier and D communication signal information measured at a corresponding location from a user terminal located in a service space; and
searching a zone where a user terminal is located by obtaining a similarity between communication signal information received from a user terminal and indexes of all zones mapped to a service.

2. The method of claim 1,
wherein similarity is either a Euclidean distance or a correlation calculated between communication signal information received from a user terminal and indexes of all zones mapped to a service, and the similarity is higher when a value of the Euclidean distance is smaller and the similarity is higher when a value of the correlation is larger.

3. The method of claim 1,
wherein communication signal information is one of positioning information including RSSI, AOA, and TOF, and communication signal information used in each layer is set independently.

4. The method of claim 3,
wherein at least one layer uses a combination of a plurality of communication signal information for zone division.

5. The method of claim 1, further comprising;
a billing data generation step of generating billing data according to positioning service usage information for each user terminal.

6. A method for providing a positioning service by dividing a service space into a plurality of layers and a plurality of zones for each layer based on communication signal information of signals transmitted by D (natural number) transmitters by a positioning service system, the method comprising:
mapping a provided positioning service and a layer set in a service space;
receiving, from a measurement terminal, D communication signal information measured at each reference position of divided zones in each layer for one service space based on layer-specific zone configuration information;
mapping and indexing D communication signal information measured and received at each reference position to a corresponding zone ID, and performing indexing sequentially from a lowermost layer to an uppermost layer;
setting a hierarchical relationship for each zone based on layer-specific zone configuration information;
configuring and storing a radio map including indexing for zones and hierarchical relationships between zones;
receiving a service identifier and D communication signal information measured at a corresponding location from a user terminal located in a service space;
searching for a zone where the user terminal is located for one or more upper layers of the layer mapped to the service, by obtaining a similarity between the communication signal information of the upper layer and that of reference position from candidate indexed zone, where all the candidate indexed zones are of all zones of the upper layer to search for a zone of the upper layer where the user terminal is located; and
searching for a zone where the user terminal is located by obtaining a similarity between the index of a zone belonging to the zone searched in the upper layer among the zones mapped to the service and the communication signal information received from the user terminal,
wherein, when the communication signal information used in the layer mapped to the service is different from the communication signal information of the upper layer, searching for a zone where the user terminal is located for the upper layer includes requesting and acquiring the communication signal information used in the corresponding layer from the user terminal.

7. A method for configuring a radio map that divides a service space into a plurality of zones based on communication signal information of signals transmitted by D (natural number) transmitters by a positioning service system, the method comprising:
receiving, from a measurement terminal, D communication signal information measured at each reference position of divided zones in each layer for one service space based on layer-specific zone configuration information;
mapping and indexing D communication signal information measured and received at each reference position to a corresponding zone ID, and performing indexing sequentially from a lowermost layer to an uppermost layer;
setting a hierarchical relationship for each zone based on layer-specific zone configuration information; and
configuring and storing a radio map including indexing for zones and hierarchical relationships between zones.

8. A positioning service system for providing a positioning service by dividing a service space into a plurality of layers and a plurality of zones for each layer based on communication signal information of signals transmitted by D (natural number) transmitters, the system comprising:
a measurement terminal measuring requested communication signal information at each reference position of zones divided for each layer based on layer-specific zone configuration information for one service space;
a user terminal periodically transmitting a service identifier and D communication signal information measured at a corresponding location in a service space; and
a service server including
a communication unit receiving measured communication signal information from the measurement terminal or receiving a service identifier and communication signal information measured at a corresponding location from the user terminal,
an indexing unit mapping and indexing D communication signal information measured and received at each reference position to a corresponding zone ID and performing indexing sequentially from a lowermost layer to an uppermost layer,
a hierarchical relationship setting unit setting a hierarchical relationship for each zone based on layer-specific zone configuration information,
a radio map configuration unit configuring and storing a radio map including indexing for zones and hierarchical relationships between zones,
a service mapping unit mapping a provided positioning service and a layer set in a service space, and
a search unit searching for a zone where the user terminal is located by obtaining a similarity between communication signal information received from the user terminal and indexes of all zones mapped to a service.

9. The system of claim 8,
wherein similarity is either a Euclidean distance or a correlation calculated between communication signal information received from the user terminal and that of reference position from candidate indexed zone, where all the candidate indexed zones are mapped to a service, and the similarity is higher when a value of the Euclidean distance is smaller and the similarity is higher when a value of the correlation is larger.

10. The system of claim 8,
wherein communication signal information is one of positioning information including RSSI, RSRP, RSRQ, AOA, and TOF, and communication signal information used in each layer is set independently.

11. The system of claim 10,
wherein at least one layer uses a combination of a plurality of communication signal information for zone division.

12. The system of claim 8,
wherein the search unit searches for a zone where the user terminal is located for one or more upper layers of the layer mapped to the service, and searches for a zone where the user terminal is located by obtaining a similarity between the index of a zone mapped to the service that belongs to the zone searched in the upper layer and the communication signal information received from the user terminal.

13. The system of claim 8, further comprising:
a billing server for generating billing data according to positioning service usage information for each user terminal.

14. The system of claim 13,
wherein the billing server generates higher billing data as usage time or number of uses of a service used by the user terminal increases.
